(19) United States
(12) Patent Application Publication
(10) Pub. No.: US 2023/0153775 A1
(43) Pub. Date: May 18, 2023

(54) MIXD CONTENT DEVICE INCLUDING NON-FUNGIBLE TOKENS (NFTs) AND SYSTEMS FOR PUBLICATION AND DISTRIBUTION

(71) Applicant: MIXD MEDIA, LLC, Santa Monica, CA (US)

(72) Inventors: Steven F Stuart, Santa Monica, CA (US); Devin Jeffrey Herbers, Venice, CA (US)

(21) Appl. No.: 17/988,702

(22) Filed: Nov. 16, 2022

Related U.S. Application Data
(60) Provisional application No. 63/279,907, filed on Nov. 16, 2021.

(51) Int. Cl. G06Q 20/12; G06Q 20/38; H04L 9/32

(52) U.S. Cl. CPC G06Q 20/123; G06Q 20/38215; H04L 9/3213; G06Q 2220/145; H04L 2209/60

(57) ABSTRACT

A computer-implemented method includes creating a digital media list or collection or digital media files; storing the created digital media list or collection or digital media files on a content device; assigning the content device a unique digital encrypted identification code and store in a database; receiving payment confirmation from a payment processing computing device that a consumer has purchased the content device with the created digital media list or collection or digital media files; and creating shipping information for the purchased content device.

### RELATED APPLICATION

This application is related to and claims priority to the U.S. provisional patent application Ser. No. 63/279,907, filed Nov. 16, 2021, entitled “MIXD CONTENT DEVICE INCLUDING NON-FUNGIBLE TOKENS (NFTs) AND SYSTEM FOR PUBLICATION AND DISTRIBUTION”, the disclosure of which is hereby incorporated by reference.

### BACKGROUND OF THE DISCLOSURE

A replica cassette tape mobile record/playback device or content device is not present to be utilized by consumers. Accordingly, there is a need for a replica cassette tape mobile record/playback device or content device.

### BRIEF DESCRIPTION OF DRAWINGS

A better understanding of the features, advantages and principles of the present disclosure will be obtained by reference to the following detailed description that sets forth illustrative embodiments, and the accompanying drawings of which:

FIG. 1 illustrates a block diagram of modules and interfaces of a replica cassette tape mobile record/playback device or content device according to some embodiments;

FIG. 2 illustrates a flowchart of utilization of a mix tape or content device according to embodiments;

FIG. 3 illustrates a MIXD content device distribution and ownership system according to some embodiments;

FIG. 4 illustrates a method of managing MIXD content device distribution and ownership utilizing a non-fungible token (NFT) according to some embodiments;

FIG. 5 illustrates an alternative method of managing MIXD content device distribution and ownership utilizing a non-fungible token (NFT) according to some embodiments;

FIG. 6 illustrates for a flowchart of a method of non-fungible token (NFT) transfer when MIXD (replica) content devices are resold according to some embodiments of the invention;

FIG. 7 illustrates a method of managing MIXD vinyl record distribution and ownership utilizing a non-fungible token (NFT) according to some embodiments;

FIG. 8 illustrates an alternative method of managing MIXD vinyl record distribution and ownership utilizing a non-fungible token (NFT) according to some embodiments; and

FIG. 9 illustrates a vinyl record including a MIXD component or assembly according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

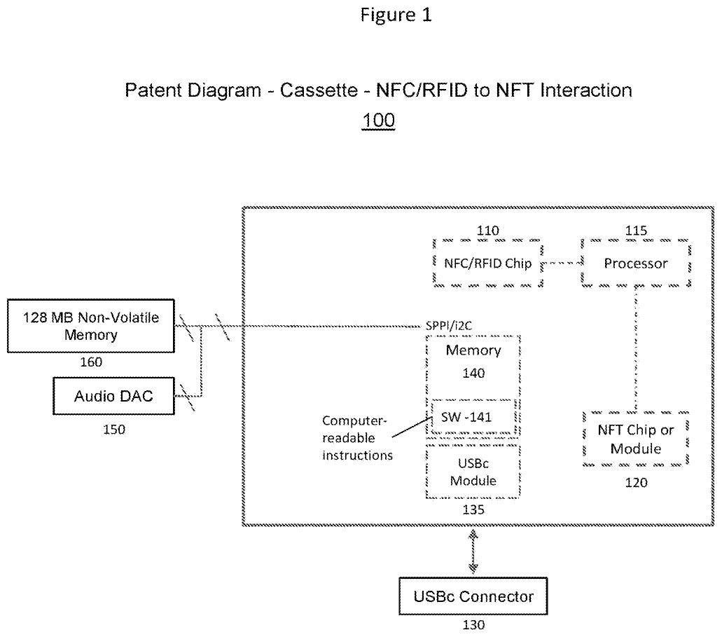

FIG. 1 illustrates a block diagram of modules and interfaces of a replica cassette tape mobile record/playback device or content device according to some embodiments. In some embodiments, a replica cassette tape mobile record/playback device or content device 100 may comprise a chip, a processor chipset or integrated circuit 105 including one or more processors 115 (only one is shown), a USB module 135 or other storage module, computer-readable instructions stored in one or more memory devices 140, and a serial interface (e.g., either Serial Peripheral Interface or Inter-Integrated Circuit Interface and/or an input/output port 141 for communicating with peripheral devices). This is just a representative embodiment and many other components and/or modules may be included on the chipset or integrated circuit 105. In some embodiments, the one or more processors 115 may include one or more baseband processors and/or audio processors. In some embodiments, the replica cassette tape mobile record/playback device or content 100 may comprise a USB connector or other memory interface 130, one or more memory devices 142, an audio digital-to-analog converter 150, and one or more 128 MB non-volatile memory devices 160. In some embodiments, the replica cassette tape mobile record/playback device or content device 100 may include one or more NFC/RFID chip or module 110 and/or non-fungible token (NFT) chip or module 120. In some embodiments, as illustrated in FIG. 1, these devices or assemblies may not be located on the processor chipset 105. In some embodiments, a rechargeable battery may provide power to the replica cassette tape mobile record/playback device or content device 100. In some embodiments, the rechargeable battery may also provide power to one or more battery charging assemblies and/or battery management circuitry or hardware. In some embodiments, the rechargeable battery may be a LiPo battery. In some embodiments, the battery management hardware and/or circuitry may comprise over/under voltage and/or current circuitry and/or thermal circuitry.

As illustrated in FIG. 1, in some embodiments, the one or more memory devices 160 may store the music files or audio files, NFTs, NFT files and/or other content files (and/or the links to the same) downloaded to the MIXD cassette device or content device 100. In some embodiments, the one or more memory devices 160 may store indicators and/or links to the music files or audio files, NFTs, NFT files and/or other content files. In some embodiments, the one or more memory devices 140 may store the embedded software including the operating system that controls operations of the MIXD cassette device or content device 100. In some embodiments, the MIXD software on the mobile communication device may control operations of the MIXD cassette device or content device. In some embodiments, the one or more memory devices 150 (storing audio data, NFTs, NFT files and/or other content files and/or links to the same) may be in the same physical memory devices as the one or more memory devices 140 storing the embedded MIXD operating software (but in different sections or partitions).

In other embodiments, the one or more memory devices 150 (storing music and audio data or music playlists) may be in separate physical memory devices from the one or more memory devices 140 storing embedded MIXD operating software.

In some embodiments, the processor chipset 105 may be a system-on-a-chip (SoC) or another chipset that combines multiple components together. In these embodiments, the processor chipset 105 may comprise one or more processors.

In some embodiments, computer-readable instructions 116 may be stored on the one or more memory devices may be embedded in a PROM, ROM or flash memory (e.g., a memory device 140) that is part of the chip, integrated circuit and/or the processor chipset 105. In some embodiments, a portion of the computer-readable instructions 116 may comprise wireless communication drivers, operating software, NFC/RFID modules 110 for handling NFC/RFID communications, NFT module software for handling working with NFTs or NFT files, as is illustrated in FIG. 1. In some embodiments, a portion of the computer-readable instructions 116 may comprise a NFC or RFID software driver and/or mobile communication device pairing driver software.

In some embodiments, the computer-readable instructions 116 stored on the one or more memory devices 160 may be executable by one or more processors 115 to store (or to cause to be stored) up to 128 MB of audio data, content files, NFTs and/or NFT files on the one or more memory devices 160. In some embodiments, the computer-readable instructions 116 executable by one or more processors of the MIXD cassette tape or content device 100 and/or one or computer-readable instructions executable by one or more processors of the mobile communication device may control headphone, audio, and/or wireless communication outputs. In some embodiments, the computer-readable instructions 116 on the MIXD cassette tape (or content device) and/or one or computer-readable instructions executable by one or more processors of the mobile communication device may be executable by one or more processors 115 to control the rechargeable battery, the battery charger or charger assembly, and/or battery management hardware and/or circuitry. In some embodiments, the computer-readable instructions 116 on MIXD cassette tape (content device) and/or one or computer-readable instructions executable by one or more processors of the mobile communication device may be executable by one or more processors 115 to control communications and/or data transfer via the USB connector 130 and/or the USB module and/or the NFC/RFID Chip or Module 110. In some embodiments, the computer-readable instructions 116 executable by the one or more processors 115 of MIXD cassette tape (or content device) and/or one or computer-readable instructions executable by one or more processors of the mobile communication device may control interaction with the USC connector 130 and/or the NFC/RFID module 110. In some embodiments, the computer readable instructions 116 executable by the one or more processors 115 of the MIXD cassette tape (or content device) 100 and/or one or computer-readable instructions executable by one or more processors of the mobile communication device may control interaction with the one or more button inputs or control buttons. In some embodiments, the computer-readable instructions 116 executable by the one or more processors 105 of the MIXD cassette tape (or content device) and/or one or computer-readable instructions executable by one or more processors of the mobile communication device may control interaction with the audio output and/or the audio digital-to-analog converter 950. In some embodiments, the computer-readable instructions 116 may be stored in a memory that is not on the processor chipset 105 and also not part of the one or more memory devices 160 storing the audio files or music files.

In some embodiments, an MIXD application programming interface (“API”) (e.g., computer-readable instructions executable by one or more processors) may communicate with a MIXD software application residing on and/or executable by one or more processors on a mobile communications device in order to interface with and/or communicate with the replica cassette tape mobile record/playback device 100. In some embodiments, the MIXD software app (on the mobile communication device) may interface with the MIXD API to create, read, update and/or delete stored media on the replica cassette tape mobile record/playback device or content device 100. In some embodiments, the MIXD software app may interface with the MIXDTAPE API to read and/or update the firmware on the replica cassette tape mobile record/playback device or content device 100. In some embodiments, the MIXD software app may interface with the MIXD API to read the replica cassette tape mobile record/playback device or content device battery charge level as well as the battery health.

In some embodiments, the software stored in one or more memory devices of the replica cassette tape mobile record/playback device or content device 100 may be executable by one or more processors to perform and/or control a number of features and/or functions. In some embodiments, the software stored in the one or more memory devices of the mobile communication device may be executable by one or more processors to perform and/or control a number of features and/or functions of the content device or MIXD cassette tape. In some embodiments, the MIXDTAPE device embedded software and/or the MIXD mobile application software may communicate with additional Bluetooth, NFC, and/or RFID enabled devices based on proximity (e.g., signal strength) in order to pair the MIXDTAPE device 100 with additional Bluetooth-, NFC- and/or RFID-enabled devices. In some embodiments, the MIXDTAPE device embedded software and/or the MIXD mobile application software may allow rechargeable battery status to be viewed by communicating with LEDs (or other lighting devices) to display a certain pattern. In some embodiments, the MIXDTAPE device embedded software and/or the MIXD mobile application software may interface with an on/off button (or other similar device) in order to recognize activation (e.g., turning on) or deactivation (e.g., turning off) of the MIXDTAPE device or content device 100. In some embodiments, the MIXD device embedded software and/or the MIXD mobile application software may interface with the 128 MB Non-Volatile Memory Device to play the audio files stored on the 128 MB Memory Device and to reproduce the audio files on an attached speaker and/or on a paired external device. In some embodiments, the MIXDTAPE device embedded software and/or the MIXD mobile application software may pause the playback of the audio files stored on the 128 MB Non-volatile memory device in response to an associated input. In some embodiments, the MIXDTAPE device embedded software and/or the MIXD mobile application software may fast forward one or more tracks and/or segments of the audio files in response to an associated input on the MIXDTAPE device or content device 100. In some embodiments, the MIXDTAPE device embedded software and/or the MIXD mobile application software may rewind one or more tracks and/or segments of the audio files in response to an associated input on the MIXDTAPE device or content device 100. In some embodiments, the MIXDTAPE device embedded software and/or the MIXD mobile application software may be able to switch playlists (e.g., sides) of the audio files in response to an associated input. In some embodiments, the MIXDTAPE device embedded software and/or the MIXD mobile application software may control output volume (e.g., increase and/or decrease) of the playback on the paired or connected external device in response to an associated input. In some embodiments, the MIXDTAPE device embedded software and/or the MIXD mobile application software may be able to limit the amount of songs and/or audio files that are recorded on the 128 MB Memory Device. In some embodiments, the MIXDTAPE application software (on the mobile communication device) (or a combination of the MIXDTAPE device embedded software and application software) may be able to limit the amount of songs and/or audio files and/or NFTs/NFT files and/or content files and/or indicators or links to any of these files, that are recorded on the 128 MB Memory Device 160 and/or other memory devices.

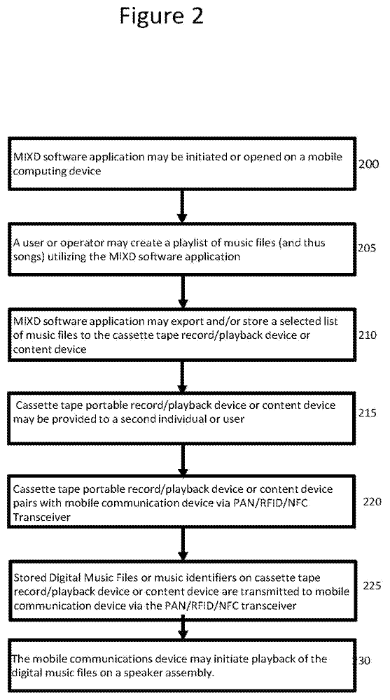

FIG. 2 illustrates a flowchart of utilization of a mix tape or content device according to embodiments. In embodiments, a mix tape or MIXD software application may be initiated or opened 200 on a mobile computing device. In embodiments, a MIXD software application may comprise computer-readable instructions stored in one or more memory devices and executable by one or more processors. In embodiments, portions of a MIXD software application may be located and/or executable by one or more processors on a mobile computing device. In embodiments, portions of a MIXD software application may be located and/or executable by one or more processors on a server computing device. In other words, the MIXD software application may be a client-server software applications where portions are executed on the mobile computing device and other portions are executed on a server computing device. In embodiments, a MIXD software application may be accessed not only from a mobile computing device, but also a laptop computing device, a wearable computing device, a desktop computing device or smart phone.

In embodiments, a MIXD software application may allow a user or operator to select a group of music files or songs to store onto a playback device (e.g., a cassette-shaped housing comprising at least one Universal Serial Bus device or a content device). In embodiments, a user or operator may import a playlist from Google Play, Pandora, Spotify, iTunes and/or another digital music software application. In embodiments, a user or operator may create 205 a playlist of music files (and thus songs) utilizing the MIXD software application.

In embodiments, a MIXD software application may store 210 a selected list of music files to the replica cassette portable playback device or content device. This allows the selected list of music files to be shared with another party. In embodiments, a cassette tape record/playback device or content device 100 may only have a limited amount of storage space in order to mimic the actual capacity of one of the original cassette tapes. In embodiments, for example, an album used to be stored on a cassette tape and for example may only be 1 Gigabyte of storage. To be consistent with the original cassette tape, the cassette tape record/playback device may be limited to storing 1 Gigabyte of storage data.

In embodiments, the replica cassette tape portable record/playback device or content device may be provided 215 to a second individual or user. In embodiments, the cassette tape record/playback device or content device provides excellent protection from external environmental elements or other substances as compared to a typical USB device because the USB device 115 is integrated into an interior of a cassette tape record/playback device or content device. In addition, a cover 116 of the USB device may be integrated into the cassette tape record/playback device or content device. In some embodiments, a USB device may not be utilized. In some embodiments, other storage devices may be utilized.

In embodiments, the cassette tape portable record/playback device or content device may pair 220 with a mobile communication device via a personal area network (PAN) transceiver, via a near field communication (NFC) transceiver, or via a radio frequency identification (RFID) transceiver (all of which may be referred to as local wireless transceivers). In embodiments, a PAN transceiver may be a Bluetooth transceiver. In alternative embodiments, a PAN transceiver may be a Zigbee transceiver or other short-range transceivers. In embodiments, a PAN transceiver may be integrated into a USB device or another storage device. In some embodiments, the local wireless transceiver (e.g., RFID and/or NFC transceiver) may be integrated into the content device.

In embodiments, the PAN transceiver, RFID transceiver and/or NFC transceiver may transmit or play (or stream) 225 the stored digital music files on the cassette tape record/playback or a content device to a mobile communication device. In embodiments, this transmission or communication is not a transfer of the music file because the music file is played and not transferred onto the mobile communication device. In some embodiments, the PAN transceiver, the RFID transceiver and/or the NFC transceiver may transmit song lists or identifiers to the mobile communication device and the mobile communication device may retrieve the associated music files from a streaming service and/or a proprietary music streaming service.

In embodiments, the mobile communications device may initiate 230 playback of the digital music files on a speaker assembly and/or playback device. In embodiments, the music native files may be stored on the replica cassette device or content device or indicators may be stored on the replica cassette device or content device. If indicators are stored on the replica cassette device or content device, the music may then be streamed from a MIXD database and/or a third-party music database (e.g., Pandora or other commercial) device. In embodiments, the speaker assembly may be located or integrated into the mobile communications device. In embodiments, the speaker assembly may be another Bluetooth-enabled device or smart device) or may be an Amazon Alexa speaker, or a Google Bluetooth-enabled speaker. In some embodiments, the communication to the speaker assembly and/or playback device may utilize NFC and/or RFID communications. In embodiments, a speaker assembly may be part of an audio receiver to which the cassette tape record/playback device may be connected or coupled

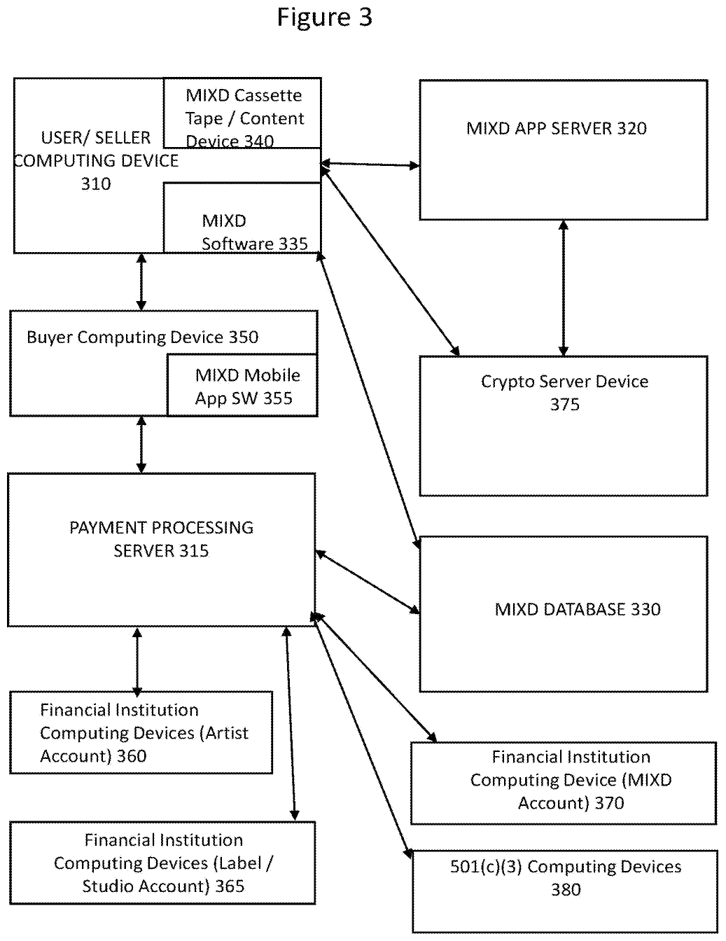

In the prior MIXD MEDIA LLC patent, the devices that received or stored content or content identifiers or indicators was referred to as a MIXD cassette device. However, other form factors may be utilized to received, store and/or interface with content and/or content identifiers. Within the present application, these devices may be referred to as MIXD content devices and/or MIXD content identifier devices. These terms may be utilized interchangeably. As discussed above, in some embodiments, users of the MIXD system may create collections of digital media files and/or may create digital media lists. In some embodiments, the users may purchase a MIXD content device and the collection of digital media files and/or digital media lists may be stored on the MIXD content device. In some embodiments, the MIXD content device may have a cassette tape form factor (e.g., a MIXD cassette tape), a mini-cassette form factor (e.g., a MIXD mini-cassette), a lanyard with memory and electronic components (e.g., a MIXD lanyard), a USB device (e.g., a MIXD USB), a digital wristband (e.g., a MIXD wristband), a digital necklace (e.g., a MIXD necklace), a new CD/DVD (e.g., a MIXD CD/DVD), and/or a physical crypto device (e.g., a MIXD Crypto device), Each of these may be referred to as a MIXD content device. In addition, as will be detailed later, the subject matter described herein may be implemented and/or integrated into digital media storage devices (e.g., vinyl records, existing CD, and/or existing DVD). In these embodiments, a sticker or other component may be positioned on the existing digital media storage device and/or integrated into a portion of the digital media storage device that is not utilized to store the digital media. Each of the above devices, form factors and/or apparatuses may include one or more processors, one or more memory devices and/or computer-readable instructions stored in the one or more memory devices and/or executable by the one or more processors to interface with the rest of the MIXD system described in FIG. 3.

In some embodiments, digital media files include music files, video files and/or digital art files. In some embodiments, digital media lists may be list for music files, video files, digital art and/or identifiers and/or uniform resource locators (“urls”) (or other links) to web sites and/or streaming services. As described above, a MIXD content device may be utilized to transfer and/or store media files and/or media lists or identifiers. In addition, the MIXD content device may be utilized to transfer and/or communicate the stored media files and/or media lists to media players on other devices, such as mobile communication devices, mobile computing devices, and/or other computing devices or audio or video players.

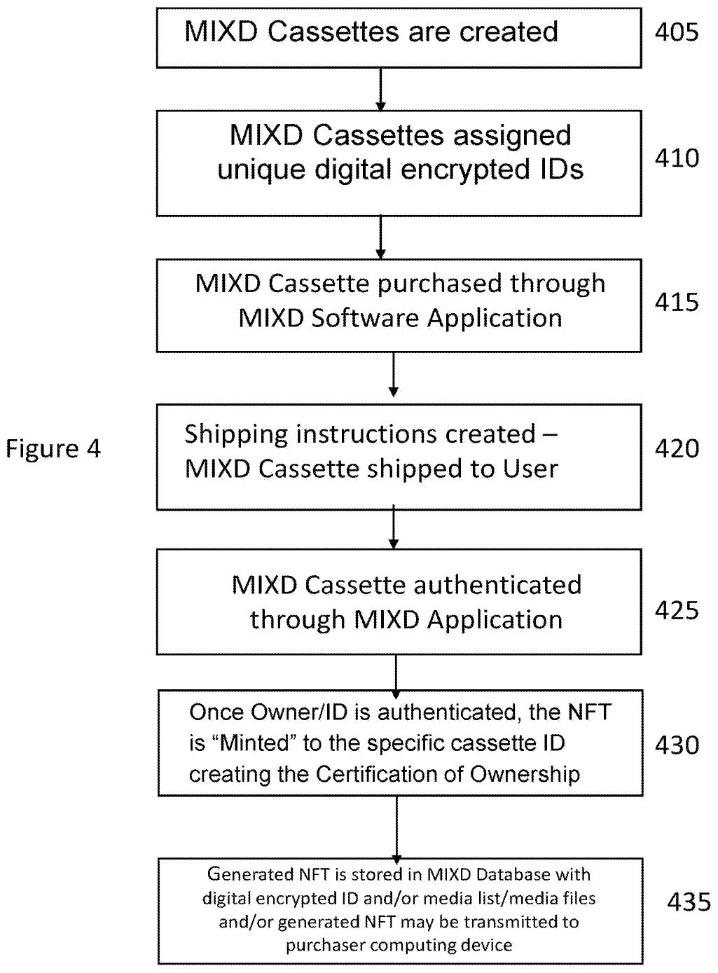

FIG. 3 illustrates a MIXD content device distribution and ownership system according to some embodiments. FIG. 4 illustrates a method of managing MIXD content device distribution and ownership utilizing a non-fungible token (NFT) according to some embodiments. In some embodiments, a user may create a digital media list or collection (e.g., song list, video list, song identifiers, media identifiers, etc.) and/or digital media files (sound files, video files, etc.) for a MIXD content device utilizing the system and/or process described above and/or in prior patent applications. In some embodiments, in step 405, the digital media list and/or digital media files created by the consumer or user may be stored on a MIXD content device. In some embodiments, the MIXD cassette tape may be packaged for customers or users. In some embodiments, in step 410, the MIXD content device may be assigned a unique digital encrypted identification code. In some embodiments, the digital media list (and/or digital media files) and/or the associated unique digital encrypted identification may be stored in the MIXD database 330. In some embodiments, this process may be repeated a number of times for all users that purchase MIXD content devices in a specific time period.

In some embodiments, a user may purchase a MIXD content devices utilizing the MIXD application, the MIXD website and/or a third-party site (through a MIXD application programming interface). This may occur when a user's computing device 310 logs into the MIXD application server computing device 320 to purchase the MIXD content device. In some embodiments, in step 415, the MIXD server computing device 320 may receive payment confirmation from a third-party payment processing computing device 315 or a MIXD payment processing server that the user or consumer has purchased the MIXD content device. In some embodiments, after receiving payment confirmation, in step 420, the MIXD server computing device may create shipping information for the purchased MIXD content device. In some embodiments, the purchased MIXD content device may be shipped to the user or consumer. In some embodiments, the user may receive the purchased MIXD content device.

In some embodiments, a user may utilize the MIXD mobile software application 335 to authenticate the MIXD content device. In some embodiments, in step 425, the MIXD software application may access or retrieve the unique digital encrypted identification code from the MIXD content device and may communicate the retrieved unique digital ID code to the MIXD server computing device 320. In some embodiments, the MIXD server computing device 320 may receive the unique digital encrypted identification code for the user's purchased content device and compare this code to the digital encrypted identification code stored in the MIXD database for the content device. If the MIXD content device is authenticated by the server computing device 320, in step 430, the MIXD server computing device 320 may mint, assign or generate a non-fungible token (NFT) on a public registry for the MIXD cassette tape. In some embodiments, the MIXD server computing device 320 may assign a previously minted NFT. In some embodiments, the NFT may represent the certification or certificate of ownership of the MIXD content device for the user and/or the owner. In some embodiments, in step 435, the generated NFT may be stored with the digital media list (and/or digital media files) and/or the associated unique digital encrypted identification in the MIXD database 330. The minting of the NFT makes the NFT part of a blockchain (e.g., like the Ethereum blockchain). This means the minted NFT to be unchangeable and tamperproof and part of a public ledger (and thus easier to authenticate). In some embodiments, the generated NFT may be communicated and/or transmitted to the user or purchaser computing device in order to be stored on the user or consumer's MIXD content device. In some embodiments, the generated NFT may be stored on a user or consumer's digital crypto wallet.

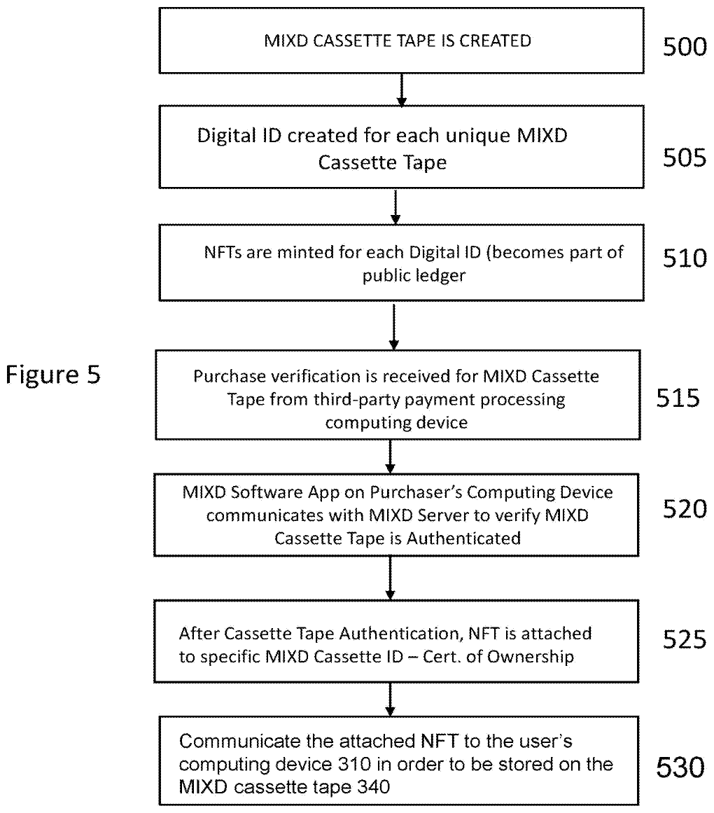

FIG. 5 illustrates an alternative method of managing MIXD content device distribution and ownership utilizing a non-fungible token (NFT) according to some embodiments. In some embodiments, the user may create a digital media list (e.g., a song list, a video list, a digital art list) and/or a digital media file grouping or mixtape utilizing the MIXD tape mobile application 335 and/or the MIXD server computing device 320. In some embodiments, in step 505, the digital media list and/or digital media file collection may be stored on the MIXD content device. In some embodiments, in step 510, the MIXD content device may be assigned a unique digital encrypted identification code. In some embodiments, the digital media list or the digital media file collection and/or the associated unique digital encrypted identification may be stored in the MIXD database 330. In some embodiments, the purchaser's name (or owner's name) may also be stored and/or associated with the digital media list, digital media file collection and/or unique digital encrypted identification code. In some embodiments, this process may be repeated a number of times for all users that purchase MIXD content devices in a specific time period.

In some embodiments, in step 515, the MIXD application server computing device 320 may generate, create and/or mint a non-fungible token (NFT) for each of the unique digital encrypted identification codes. In some embodiments, the generated or minted NFTs may be stored in the MIXD Database 330 and associated with the unique digital encrypted ID along with the digital media list and/or the digital media file collection.

In some embodiments, a user may purchase a MIXD content device utilizing the MIXD mobile software application 335, the MIXD website or application server computing device 320 and/or a third-party site (through a MIXD application programming interface). In some embodiments, in step 520, the MIXD server computing device may receive payment confirmation from a third-party payment processing computing device 315, a crypto server payment computing device or a MIXD payment processing server that the user or consumer has purchased the MIXD content device.

In some embodiments, the MIXD content device may be received from the consumer or user. In some embodiments, the user or consumer may utilize the MIXD mobile software application 335 on the mobile computing device 310 in order to register the received MIXD content device with the MIXD application server computing device 320. In some embodiments, the mobile computing device 310 (using the MIXD mobile software application 335) may communicate the digital encrypted ID code and/or the digital media list and/or the digital media file collection to the MIXD application server computing device 320. In some embodiments, in step 525, the MIXD application server computing device 320 may authenticate the user's MIXD content device by comparing the received digital encrypted ID code and/or digital media list and/or the digital media file collection with similar information stored in the MIXD database. If the user's MIXD content device is authenticated, in step 530, then the MIXD application server computing device 320 may attach the NFT to the specific user MIXD content device. In some embodiments, in step 535, the MIXD application server computing device 320 may communicate the attached NFT to the user's computing device 310 in order to be stored on the MIXD content device 340 by the MIXD application software 335.

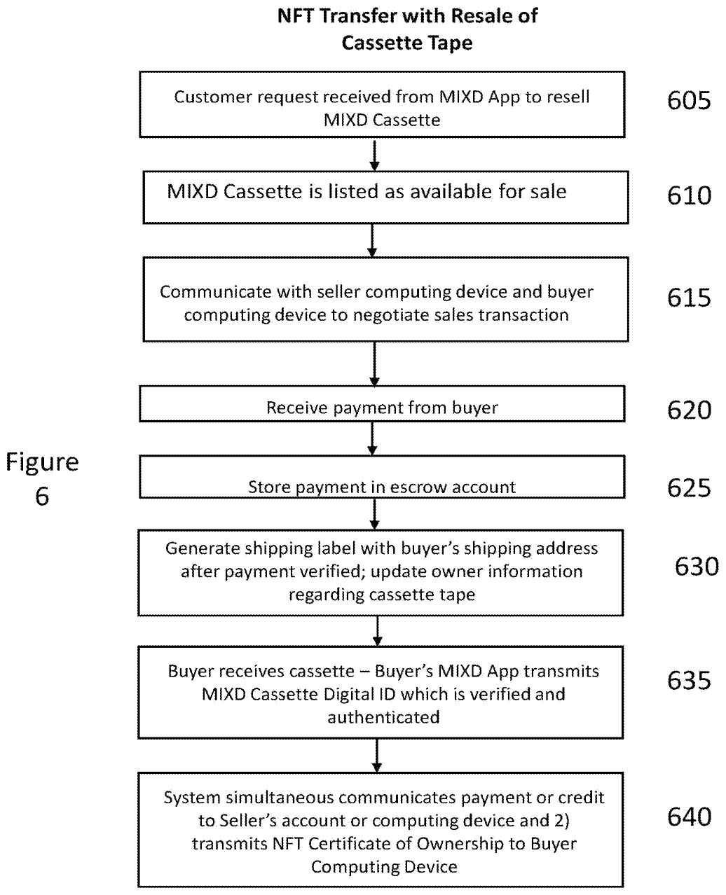

FIG. 6 illustrates for a flowchart of a method of non-fungible token (NFT) transfer when MIXD (replica) content devices are resold according to some embodiments of the invention. In some embodiments, a consumer or user may decide to resell their MIXD content device to another user. In some embodiments, the user or consumer may login into the MIXD mobile application software 335 on the user computing device 310 and, in step 605, may transmit or communicate a content device transfer request to the MIXD application server computing device 320. In some embodiments, in step 610, the MIXD application server computing device 320 may list or offer the replica content device to other consumers or users who login to their MIXD software application. In some embodiments, the transfer request may also be associated with the digital encrypted ID for the replica content device in the MIXD database 330. In some embodiments, the NFTs may be sold and/or resold via a NFT marketplace, such as Crytpo.com NFT marketplace, OpenSea NFT marketplace, Rarible NFT marketplace, and/or MakersPlace NFT marketplace. NFTs may be embodied in hardware, a physical item, a software or a combination of these prior items.

In some embodiments, in step 615, the MIXD application server computing device 330 engages sellers (through seller computing devices 310 and buyer computing devices 350) to negotiate a price of sale for the seller's MIXD content device. In some embodiments, the seller (through the seller computing device 310) may establish a sell price or ask price and the buyer (through the buyer computing device 350) may respond to that price and/or may barter or negotiate. In some embodiments, the MIXD mobile software application 335 on the seller computing device 310 and the MIXD mobile software application 355 on the buyer computing device 350 may have communications functionality such as a chat application that allows the seller and/or buyer to ask and answer questions and to negotiate a sales price. In some cases, the MIXD application server computing device 320 may have a market price established for resold MIXD content devices. In some cases, this may be based on recent reselling transactions between buyers and/or users.

In some embodiments, after the sale price is negotiated, the MIXD application server computing device 330 requests that the buyer (through the mobile application software 355 on the buyer computing device 350) to make a payment to purchase the seller's MIXD cassette tape. In some embodiments, in step 620, the buyer (through the buyer computing device 350) may communicate with a third-party payment processing server 315 or a MIXD payment processing server to make a payment in the amount of the negotiated sale price. In some case, the buyer may utilize crypto-currency and in some cases, the buyer may utilize debit or credit cards, or third-party payment systems such as Zelle and/or PayPal. In some embodiments, in step 625, the payment processing server 315 (whether third-party or MIXD) may transfer a payment or a credit representative of the payment to a MIXD escrow account. The payment is thus kept from the seller until the seller fulfils their end of the transaction.

In some embodiments, in step 630, the MIXD application server computing device 320 creates shipping instructions after confirmation of the buyer's payment has been received from the payment processing system 315. In these embodiments, the seller computing device may receive the shipping instructions and the seller ships the seller's MIXD cassette tape to the buyer. In some embodiments, the buyer receives the seller's MIXD cassette tape and logs into the MIXD mobile application software 355 on the buyer's computing device and in step 635 provides the encrypted digital identifier code and the new owner information to the MIXD application server computing device 320 in order to authenticate the sale and/or verify that the sale information matches the sales transaction information stored in the MIXD application server computing device 320 and/or MIXD database 330.

In some embodiments, the MIXD application server computing device 320 transmits payment instructions to the payment processing server 315 to send payment to the seller's account so that the buyer receives their money. In step 640, At approximately the same time, or simultaneously, the MIXD application server computing device 320 attaches and/or communicates that the NFT is now attached to the new owner computing device. In some cases, the NFT may remain the same and may be transferred to a new owner's wallet address in the MIXD database 330. In some cases, this could require that a new NFT be created or minted in order to transfer the ownership. In other cases, the MIXD application server computing device 320 could communicate new owner information (e.g., the buyer's information) to the MIXD database 330 to update the record for the MIXD cassette type and identify the ownership NFT belongs to the buyer. In these embodiments, the MIXD application server computing device 320 could communicate the NFT to the buyer's computing device and the MIXD mobile application software could store the NFT with the new owner (e.g., the buyer's) information on the resold MIXD content device.

In some embodiments, a MIXD content device may also include additional items stored thereon. In some embodiments, with purchases of certain music files, video files, and/or digital art, the MIXD application server computing device 320 may add additional non-fungible tokens (NFTs) as rewards for the purchaser of the MIXD content device. In these embodiments, the additional NFTS may be attached to the purchased MIXD content device. In some embodiments, this may be exclusive digital content from creators (musicians, artists and/or directors) for purchasers of their songs. In some embodiments, the additional non-fungible tokens (NFTs) provide access to live music events (like concerts) and/or streaming media of interviews with the digital artists or creators.

In some embodiments, the ownership (or certificate of ownership) NFT may include additional information and/or parameters regarding the MIXD content device. In some embodiments, the ownership NFT may include a smart contract or distribution contract. In some embodiments, the smart contract or distribution contract may include financial distributions of the purchase price of the MIXD content device. In some embodiments, for example, the smart contract or distribution contract may include a percentage paid to the artist from the purchase price of the MIXD content device; a percentage paid to the music label or studio or promoter of the MIXD content device; a percentage paid to third party technical and/or service partners of the MIXD content device; and/or a percentage paid to MIXD from the purchase price of the MIXD content device. In some embodiments, for example, this may occur per digital media piece or file (e.g., song, video and/or painting) or if the MIXD content device is all digital media files or lists from one artist, then the smart contract may have percentages for the whole content device. In some embodiments, the MIXD application server computing device 320 may handle the execution and/or the financial distribution based at least in part on the smart contract or distribution contract. In some embodiments, the MIXD application server computing device 320 may generate payment distribution instructions and communicate the payment distribution instructions to the payment processing computing device 315. In some embodiments, the payment processing computing device 315 may transfer payments to accounts of the artists in financial institution computing devices 360, to accounts of the record label, the video or movie studio and/or the art promoter in additional financial institution computing devices 365, and/or to accounts corresponding to MIXD Media in MIXD MEDIA's financial institution's computing devices 370. In some embodiments, payments may be made from or made be received from 501(c)(3) financial institutions computing devices. In some embodiments, the payment made by the payment processing computing device 315 may be in cryptocurrency and thus may be transferred to an artist's digital wallet, a label, studio or promoter's digital wallet and/or seller's digital wallet, in a crypto server computing device 375. Many different crypto currencies may be utilized. In some embodiments, a buyer's or purchaser's account on a crypto server computing device 375 may send cryptocurrency to the payment processing computing device 315 to purchase the MIXD content device. In some embodiments, the purchase of a MIXD content device may result in a consumer receiving some cryptocurrency as a reward and/or also the artist receiving some cryptocurrency as part of the payment. In these embodiments, the payment processing computing device 315 may receive information about who should receive the cryptocurrency payment and may make arrangements to have these cryptocurrency payments made to the appropriate accounts (e.g., consumer and artist account) of the crypto server computing device 375.

In some embodiments, the MIXD content device may also be utilized as a cryptocurrency wallet. In some embodiments, the MIXD content device may be utilized for storing digital media files or digital media lists and/or be a cryptocurrency wallet. In these embodiments, the cryptocurrency server device 375 may communicate and/or transfer cryptocurrency to the MIXD content device.

In some embodiments, a vinyl record may be utilized to store the digital media lists and/or the digital media files. In this embodiment, the vinyl record device may be an album created by a record company or label. In this embodiment, the record company or label would like to include MIXD functionality as part of the vinyl record. In other words, the vinyl record would play on a record player, but would also have additional MIXD functionality (such as having an NFT to certify ownership, having another NFT with exclusive content, include access to other content as well as links to live performances as or events). In this embodiment, a component or assembly may be added to the vinyl record or album. In these embodiments, the component or assembly may be placed on top of an unused area of a vinyl record or album (e.g., the center area of the vinyl record or album) and/or may be integrated into the vinyl record or album. In some embodiments, the component or assembly may be a label, a sticker, a chip, an electronic module or other similar devices. In some embodiments, the vinyl record component or assembly may include one or more processors, one or more memory devices, and/or computer-executable instructions stored in the one or more memory device. In this embodiment, the computer-readable instructions may be executed by the one or more processors to implement the processes and methods described herein as well as to store media lists and/or digital media files in the component or assembly of the vinyl record. In some embodiments, existing vinyl records, existing CDs, and/or existing DVDs may also have MIXD functionality added to their devices. These existing vinyl records, CDs and/or DVDs would have the MIXD component or assembly described immediately above and below applied to and/or integrated into the existing devices.

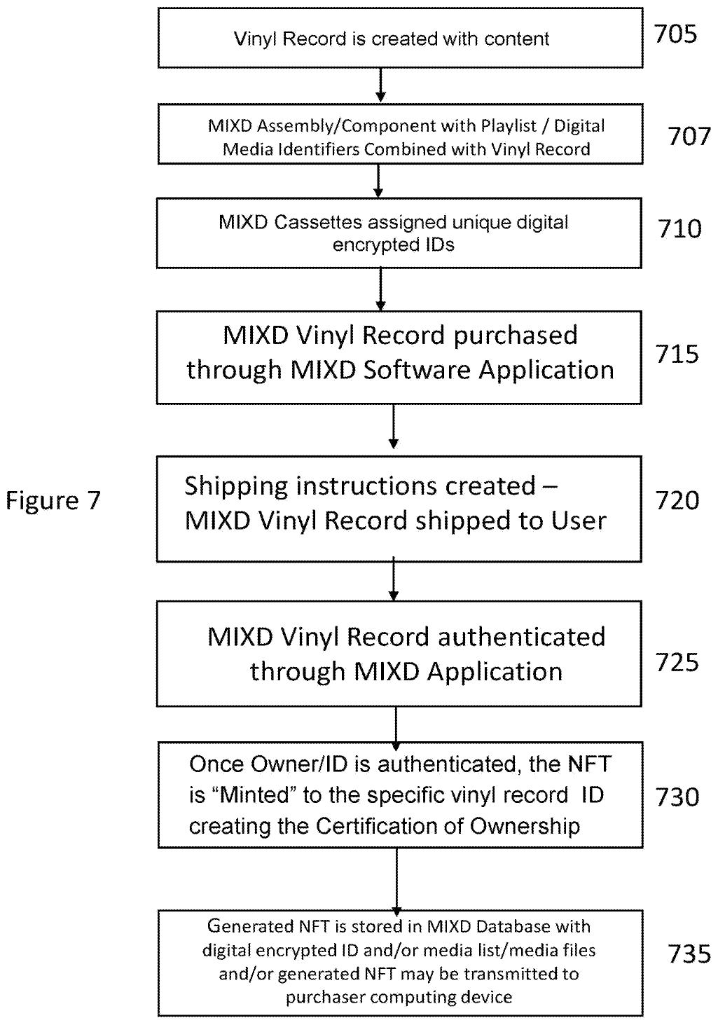

FIG. 7 illustrates a method of managing MIXD vinyl record distribution and ownership utilizing a non-fungible token (NFT) according to some embodiments. In some embodiments, the record label and/or artist may create a digital media list or collection (e.g., song list, video list, song identifiers, media identifiers, etc.) and/or digital media files (sound files, video files, etc.) for a MIXD vinyl record. In some embodiments, in step 705, the digital media files created by the record label and/or artist may be stored on a MIXD vinyl record. In some embodiments, in step 707, digital media lists or collections may be stored on the MIXD component or assembly that is part of the MIXD vinyl record. In some embodiments, the MIXD vinyl record may be packaged for sale to customers or users. In some embodiments, in step 710, the MIXD vinyl record may be assigned a unique digital encrypted identification code. In some embodiments, the digital media list (and/or digital media files) and/or the associated unique digital encrypted identification may be stored in the MIXD database 330. In some embodiments, this process may be repeated a number of times for all users that purchase MIXD vinyl records in a specific time period.

In some embodiments, a user may purchase a MIXD vinyl records utilizing the MIXD application, the MIXD website and/or a third-party site (through a MIXD application programming interface). This may occur when a user's computing device 310 logs into the MIXD application server computing device 320 to purchase the MIXD vinyl records. In some embodiments, in step 715, the MIXD server computing device 320 may receive payment confirmation from a third-party payment processing computing device 315 or a MIXD payment processing server that the user or consumer has purchased the MIXD vinyl record. In some embodiments, after receiving payment confirmation, in step 720, the MIXD server computing device may create shipping information for the purchased MIXD vinyl records. In some embodiments, the purchased MIXD vinyl records including the MIXD component or assembly may be shipped to the user or consumer. In some embodiments, the user may receive the purchased MIXD content device with the MIXD component or assembly.

In some embodiments, a user may utilize the MIXD mobile software application 335 to authenticate the MIXD vinyl record. In some embodiments, in step 725, the MIXD software application may access or retrieve the unique digital encrypted identification code from the MIXD component or assembly of the MIXD vinyl record and may communicate the retrieved unique digital ID code to the MIXD server computing device 320. In some embodiments, the MIXD server computing device 320 may receive the unique digital encrypted identification code for the user's purchased vinyl record and compare this code to the digital encrypted identification code stored in the MIXD database for the content device. If the MIXD vinyl record is authenticated by the server computing device 320, in step 730, the MIXD server computing device 320 may mint, assign or generate a non-fungible token (NFT) on a public registry for the MIXD vinyl record. In some embodiments, the MIXD server computing device 320 may assign a previously minted NFT. In some embodiments, the NFT may represent the certification or certificate of ownership of the MIXD vinyl record for the user and/or the owner. In some embodiments, in step 735, the generated NFT may be stored with the digital media list (and/or digital media files) and/or the associated unique digital encrypted identification in the MIXD database 330. In some embodiments, the generated NFT may be communicated and/or transmitted to the user or purchaser computing device in order to be stored on the user or consumer's MIXD vinyl record. In some embodiments, the generated NFT may be stored on a user or consumer's digital crypto wallet. FIG. 7 is also applicable to existing CDs, existing DVDs and/or existing vinyl records which have a MIXD component or assembly attached and/or adhered thereto.

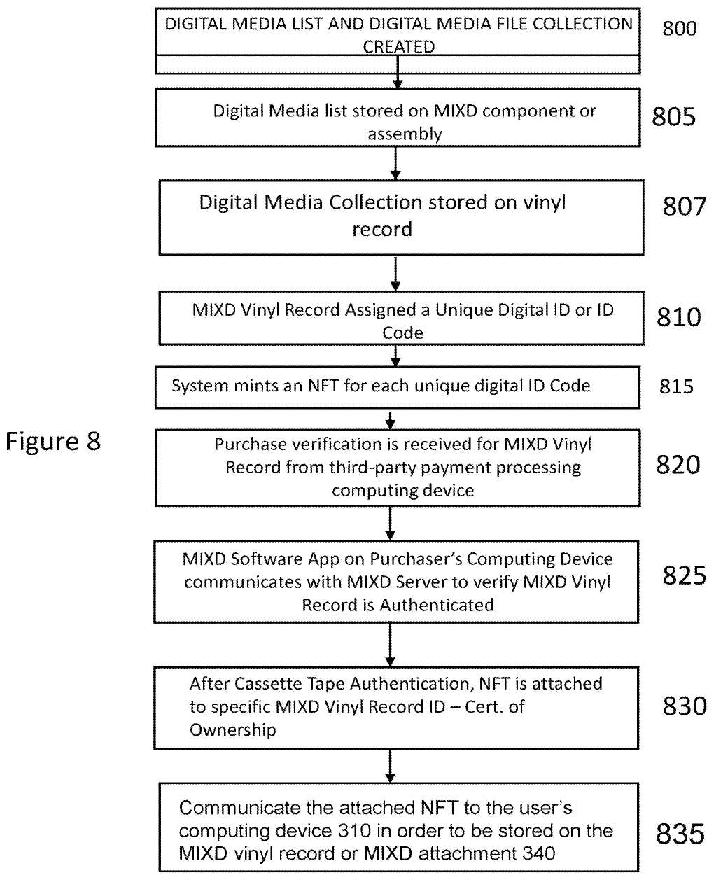

FIG. 8 illustrates an alternative method of managing MIXD vinyl record distribution and ownership utilizing a non-fungible token (NFT) according to some embodiments. In some embodiments, in step 800, the artist and/or record label may create a digital media list (e.g., a song list, a video list, a digital art list) and/or a digital media file grouping utilizing the MIXD mobile application 335 and/or the MIXD server computing device 320. In some embodiments, in step 805, the digital media list may be stored on a MIXD component or assembly of the MIXD vinyl record. In some embodiments, in step 807, the digital media file collection may be stored on the MIXD vinyl record. In some embodiments, in step 810, the MIXD vinyl record may be assigned a unique digital encrypted identification code. In some embodiments, the digital media list or the digital media file collection and/or the associated unique digital encrypted identification may be stored in the MIXD database 330. In some embodiments, the purchaser's name (or owner's name) may also be stored and/or associated with the digital media list, digital media file collection and/or unique digital encrypted identification code. In some embodiments, this process may be repeated a number of times for all users that purchase MIXD vinyl records in a specific time period.

In some embodiments, in step 815, the MIXD application server computing device 320 may generate, create and/or mint a non-fungible token (NFT) for each of the unique digital encrypted identification codes. In some embodiments, the generated or minted NFTs may be stored in the MIXD Database 330 and associated with the unique digital encrypted ID along with the digital media list and/or the digital media file collection.

In some embodiments, a user may purchase a MIXD vinyl record utilizing the MIXD mobile software application 335, the MIXD website or application server computing device 320 and/or a third-party site (through a MIXD application programming interface). In some embodiments, in step 820, the MIXD server computing device may receive payment confirmation from a third-party payment processing computing device 315, a crypto server payment computing device or a MIXD payment processing server that the user or consumer has purchased the MIXD vinyl record.

In some embodiments, the MIXD vinyl record including the MIXD component or assembly may be received from the consumer or user. In some embodiments, the user or consumer may utilize the MIXD mobile software application 335 on the mobile computing device 310 in order to register the received MIXD vinyl record including the MIXD component or assembly with the MIXD application server computing device 320. In some embodiments, the mobile computing device 310 (using the MIXD mobile software application 335) may communicate the digital encrypted ID code and/or the digital media list and/or the digital media file collection to the MIXD application server computing device 320. In some embodiments, in step 825, the MIXD application server computing device 320 may authenticate the user's MIXD vinyl record by comparing the received digital encrypted ID code and/or digital media list from the MIXD component or assembly on the MIXD vinyl record and/or the digital media file collection with similar information stored in the MIXD database. If the user's MIXD vinyl record is authenticated, in step 830, then the MIXD application server computing device 320 may attach the NFT to the specific user MIXD vinyl record (e.g., the MIXD component or assembly). In some embodiments, in step 835, the MIXD application server computing device 320 may communicate the attached NFT to the user's computing device 310 in order to be stored on the MIXD component or assembly in the MIXD vinyl record 340 by the MIXD application software 335.

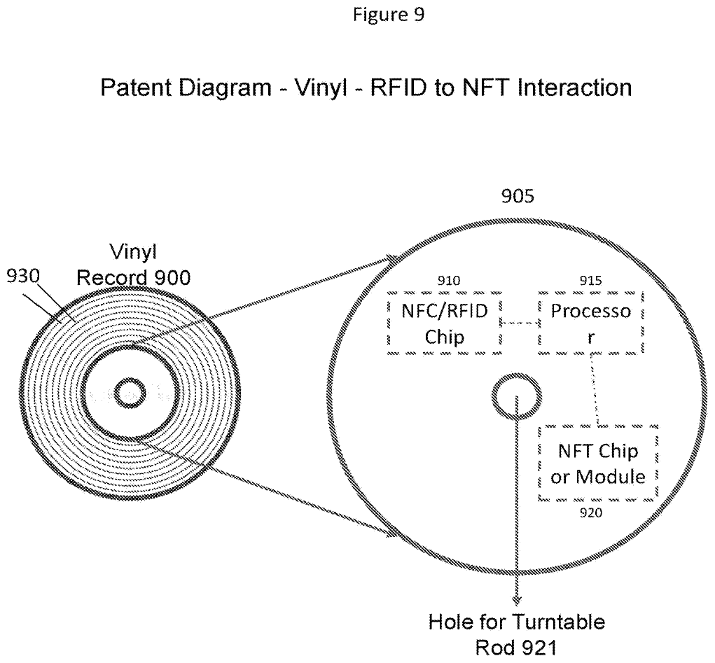

FIG. 9 illustrates a vinyl record including a MIXD component or assembly according to some embodiments. In embodiments, the vinyl record 900 may include a hole 921 for a turntable rod, tracks 930 for music and/or content 930, and/or a middle area or label area 905. In some embodiments, the middle area or label area 905 may include the MIXD component or assembly. In some embodiments, the MIXD component or assembly may be integrated into the label. In some embodiments, the label may be tamper-proof and thus may not be modified. In some embodiments, the middle area or label area 905 including the MIXD component or assembly may include one or more processors 915, one or more memory devices, one or more NFC/RFID chips or modules 910 and/or one or more non-fungible tokens (NFT) chips or modules 920. In some embodiments, the MIXD component and/or assembly may be integrated into any area on the vinyl record besides the one or more tracks of the vinyl record. In some embodiments, the one or more NFC/RFID chips or modules 105 may be hardware, software and/or a combination of both. In some embodiments, the one or more NFC/RFID chips or modules 105 may communicate with the mobile communication device and/or with other portable electronic devices. In some embodiments, the one or more NFT chips or modules 105 may be hardware, software and/or a combination of both. In some embodiments, the one or more NFT chip or module 920 may house or store one or more non-fungible tokens (NFTs) and/or links or indicators to the NFTs that have been purchased by the vinyl record user or owner.

In some embodiments, the MIXD content device may also include event access digital codes and/or passes. In some embodiments, the MIXD content device may be storing digital media files and/or digital media lists and/or digital codes and/or passes for special events such as music concerts or club events and/or art shows or galleries. In some embodiments, the digital codes and/or passes may be stored as non-fungible tokens (NFT) and/or a NFC-readable code. In these embodiments, the MIXD application server computing device 320 may generate the access digital codes and/or passes and may communicate and/or transfer the access digital codes and/or passes (e.g., as NFT tokens) to the MIXD content device.

In some embodiments, the MIXD content device may also be utilized as a digital bearer instrument, which means the MIXD content device itself may be a form of currency by itself. In other words, software may be executable on the MIXD content device that allows the MIXD content device to be utilized to make purchases for payment systems that allow digital current as payment and/or NFC-enabled devices to make payment. In some embodiments, the MIXD content device may also be utilized in its normal functional of storing digital media files and/or digital media lists and/or allowing playback or reproduction of the digital media files.

As detailed above, the computing devices, content devices, and/or systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements. Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A computer-implemented method, comprising:
retrieving computer-readable readable instructions from one or more memory devices;
executing, by one or more processors, the retrieved computer-readable instructions to:
create a digital media list or collection or digital media files;
store the created digital media list or collection or digital media files on a content device;
assign the content device a unique digital encrypted identification code and store in a database;
receive payment confirmation from a payment processing computing device that a consumer has purchased the content device with the created digital media list or collection or digital media files; and
create shipping information for the purchased content device.

2. The method of claim 1, the retrieved computer-readable instructions executable by one or more processors further to:
authenticate the content device by receiving the unique digital encrypted identification code from the consumer and compare the received unique digital encrypted identification code to the assigned unique digital encrypted identification code stored in the database.

3. The method of claim 2, the retrieved computer-readable instructions executable by one or more processors further to:
mint, assign or generate a non-fungible token (NFT) on a public registry for the purchased content device.

4. The method of claim 3, the retrieved computer-readable instructions executable by one or more processors further to:
store the generated NFT may be stored with the created digital media list or collection (and/or the digital media files) and/or the assigned unique digital encrypted identification in the database; and
communicate the generated NFT to the consumer computing device in order to be stored on the consumer's MIXD content device.

5. A computer-implemented method, comprising:
retrieving computer-readable readable instructions from one or more memory devices;
executing, by one or more processors, the retrieved computer-readable instructions to:
may create a plurality of digital media lists or a digital media file groupings;
assign a unique digital encrypted identification codes for the each of the created plurality of digital media lists or digital media file groupings;
store the unique digital encrypted identification code for each of the plurality of created digital media lists or digital media file groupings in a database;
generate a plurality of non-fungible tokens (NFTs) for each of plurality of unique digital encrypted identification codes and associated created digital media lists or digital media file groupings;
store the plurality of NFTs with the associated digital encrypted identification codes and associated created digital media lists or digital media file groupings in the database;
receive payment for a consumer's content device from a third-party payment processing computing device;
authenticate a consumer's purchased content device by receiving the digital encrypted ID code and digital media list or digital media grouping from a consumer computing device and comparing the received digital encrypted ID code and/or digital media list and/or the digital media file grouping with the stored digital encrypted identification codes and associated created digital media lists or digital media file groupings in the database; and
if the consumer's purchased content device is authenticated, attach the associated NFT to the consumer content device; and
communicate the attached NFT to the consumer's purchased content device in order to be stored on the consumer's purchased content device.

6. A computer-implemented method, comprising:
retrieving computer-readable readable instructions from one or more memory devices;
executing, by one or more processors, the retrieved computer-readable instructions to:
receive a content device transfer request from a selling consumer;
communicate with consumers regarding purchase of the content device from the selling consumer;
negotiate a sales price for the content device with a purchaser via the purchaser's computing device;
communicate a payment request to the purchaser's computing device;
receive confirmation from a payment processing device that the purchaser has paid for the content device;
create shipping instructions for the content device to have the content device shipped to the purchaser;
receive an encrypted digital identifier code and the new owner information for the purchased content device from the purchaser's computing device; and
authenticate the purchased content device and modify the purchased content device owner information with the new owner information.

7. The method of claim 6, wherein negotiating the sales price for the content device includes establishing an asking price and accepting a highest price offer received from a consumer. the retrieved computer-readable instructions executable by one or more processors further to:

8. The method of claim 6, the retrieved computer-readable instructions executable by one or more processors further to:
receive questions from potential consumer's computing devices with respect to the content device;
answer the received questions for the content device to assist in negotiating the sales price.
